(19) United States
(12) Patent Application Publication
(10) Pub. No.: US 2004/0026147 A1
(43) Pub. Date: Feb. 12, 2004

(54) PORTABLE AND COLLAPSIBLE MOTORCYCLE

(76) Inventors: Chuan-Fu Kao, Pan-Chiao City (TW); Tao-Ching Chen, Taoyuan City (TW)

Correspondence Address: Chuan-Fu Kao & Tao-Ching Chen, P.O. Box No.6-57, Chung-Ho, Taipei, 235, TW

(21) Appl. No.: 10/215,012

(22) Filed: Aug. 9, 2002

(51) Int. Cl. B62M 7/00

(52) U.S. Cl. 180/219

(57) ABSTRACT

A portable and collapsible motorcycle structure mainly includes a front wheel support, a seat support, a bottom support and a rear wheel support, wherein the joint area of the front wheel support and a handlebar support is disposed with an engagement device assembled by a gear and a tapered gear block. The joint area of the front wheel support and the bottom support is disposed with a retaining device assembled by a spring and a screw rod. A round rod is disposed between the seat support and the bottom support thereby enabling the motorcycle to have a slightly raised seat provided for riding after it is fixedly assembled by the engagement and retaining devices. When the engagement and retaining devices are separated, the motorcycle is collapsed to facilitate carriage and moving.

### BACKGROUND OF THE INVENTION

1) Field of the Invention

The present invention relates to a portable and collapsible motorcycle structure, more especially to a motorcycle structure collapsible for moving and easy for assembly.

2) Description of the Prior Art

Accordingly, the presently available mini motorcycles are usually have reduced designs of full-scaled motorcycles. Therefore, the volume thereof still occupies a certain space suitable for use in a fixed site by not for moving or carrying outdoors in any popular leisure activities. That shortcoming relatively reduces the pleasure of the activities.

### SUMMARY OF THE INVENTION

Therefore, the primary objective of the present invention is to provide a portable and collapsible motorcycle structure such that when not in use, the motorcycle can be collapsed for facilitating moving and enhancing the riding pleasure.

The collapsible motorcycle of the present invention comprises a front wheel support, a seat support, a bottom support and a rear wheel support; an engine is disposed at the rear end of the bottom support and the seat support is slightly raised for a user to ride astride.

The collapsible motorcycle of the present invention has an engagement device assembled by a gear and symmetric tapered gear blocks and disposed at the joint area of the front wheel support and the handlebar support; a retaining device assembled by a spring and a screw rod is disposed at the joint area of the front support and bottom support. The securing and the detachment of the engagement and the retaining devices make the motorcycle available for riding or collapsed for facilitating carriage.

The collapsible motorcycle of the present invention, wherein, between the seat support and the bottom support as well as between the bottom support and the rear wheel support, a round tube ad a shock absorber are disposed respectively to compose supporting and shock absorbing effects.

To enable a further understanding of the structural features and the innovation of the present invention, the brief description of the drawings below is followed by the detailed description of the preferred embodiment.

### BRIEF DESCRIPTION OF THE DRAWINGS

FIG. 1 is a perspective and schematic drawing of the present invention.

FIG. 2 is a perspective and schematic drawing of an engagement device of the present invention.

FIG. 3 is a cross-sectional and schematic drawing of a retaining device of the present invention.

FIG. 4 is a schematic drawing of the collapsed state of the present invention.

FIG. 5 is a schematic drawing of the implementing state of the present invention.

### DETAILED DESCRIPTION OF THE PREFERRED EMBODIMENTS

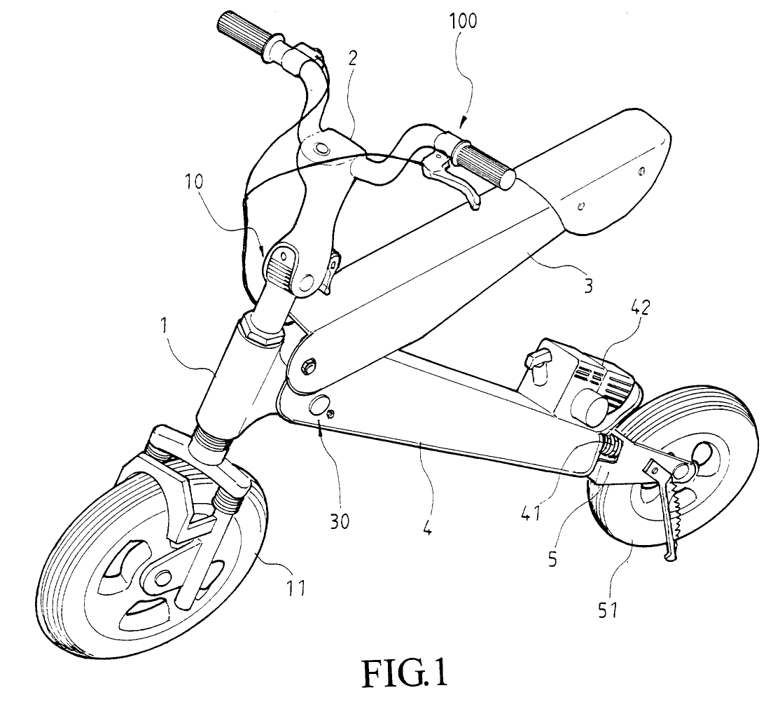

FIGS. 1 and 5 show the perspective and schematic drawing of the present invention and the schematic drawing of the implementing state of the present invention. The present invention mainly comprises a front wheel support (1), a handlebar support (2), a seat support (3), a bottom support (4) and a rear wheel support (5), wherein an engagement device (10) is disposed in the joint area of the top end of the front wheel support (1) and the handlebar support (2); a retaining device (30) is disposed in the joint area of the seat support (3) and the bottom support (4); a slanted round rod (31) is disposed between the seat support (3) and the bottom support (4); a shock absorber (41) is disposed between the bottom support (4) and the rear wheel support (5); an engine (42) is disposed on the rear rim of the bottom support (4); furthermore, a front wheel (11) and a rear wheel (51) are respectively disposed on the front wheel support (1) and the rear wheel support (5).

The abovementioned members assemble to compose a motorcycle (100) and which is collapsible for facilitating carriage and moving through the detachment of the engagement device (10) and the retaining device (30).

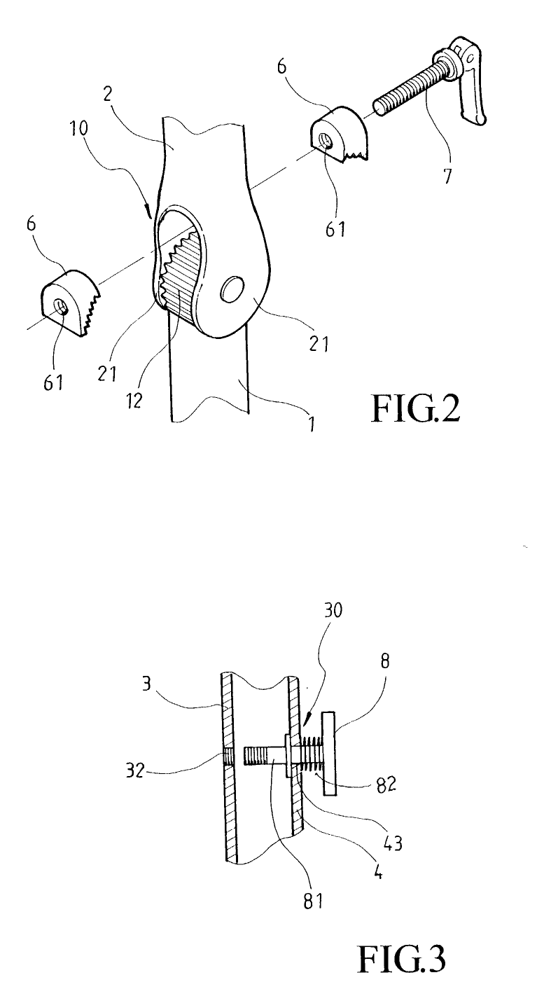

FIG. 2 shows the exploded and schematic drawing of the engagement device of the present invention which has a gear (12) disposed at the top end of the front wheel support (1); a protruding ear (21) in a semi-circled shape is disposed at the bottom end of the handlebar support (2) and secured on the gear (12) for rotating. Two tapered gear blocks (6) are engaged at two ends of the gear (12) and secured to avoid sliding by a quick detacher (7); when the quick detacher (7) is loosened, the gear blocks (6) separate from the gear (12) thereby facilitating the rotation of the handlebar support (2).

FIG. 3 shows the cross-sectional and schematic drawing of the retaining device of the present invention. The retaining device (30) has a rotary knob (8) with a bolt (18); a through hole (43) is disposed on the bottom support (4) and a screw hole (32) is disposed on the seat support (3); a bolt (81) inserts through a spring (82) and a through hole (43) for securing to or detaching from the screw hole (32) of the seat support (3) thereby facilitating the collapsibility.

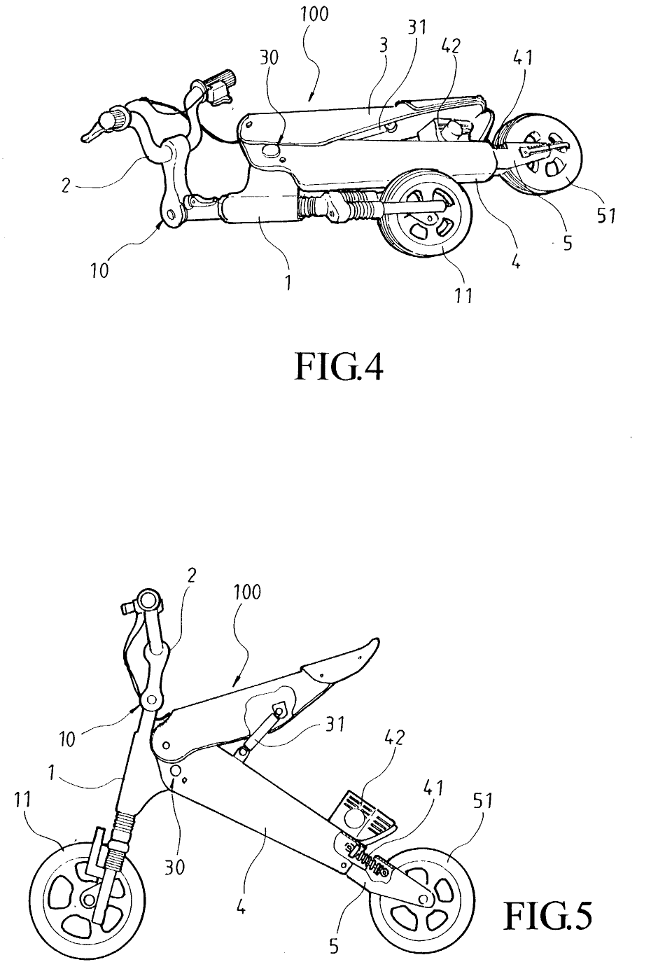

FIGS. 4 and 5 show the schematic drawings of the collapsed and implementing states of the present invention. To collapse the present invention, the engagement and retaining devices (10, 30) are detached to fold the seat support (3) and the handlebar support (2) into a collapsed state for facilitating carriage and moving. To use the present invention, the engagement and retaining devices (10, 30) are secured into a riding state for a user to ride on the seat support (3) and start the engine (42).

In summation of the abovementioned, the present invention utilizing the engagement and retaining devices to compose the motorcycle into a collapsed state for facilitating carriage and moving is of a practical and innovative design.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A portable and collapsible motorcycle mainly comprises a front wheel support, a handlebar support, a seat support, a bottom support and a rear wheel support; a front wheel and a rear wheel are respectively disposed on the front and rear wheel supports; an engine is disposed at the rear end of the bottom support for driving the motorcycle body to move; the present invention is characterized that:
a protruding ear in a semi-circular shape is disposed at the bottom end of the handlebar support; a gear is disposed at the top end of the front wheel support; the protruding ear inserts to the gear to form a rotary handle; two tapered gear blocks disposed with screw holes are engaged to two ends of the gear; a quick detacher inserts into the screw hole to secure the gear block onto or detach from the gear thereby composing the engagement device; a through hole and a screw are respectively disposed on the rear wheel support and the seat support to connect to or detach from the screw hole thereby composing a retaining device; the securing or detachment of the engagement and retaining devices composes the motorcycle into a riding or collapsed states thereby facilitating carriage and moving.

2. A portable and collapsible motorcycle according to claim 1, wherein a round rod and a shock absorber are disposed respectively between the seat support and the bottom support as well as between the bottom support and the rear wheel support thereby achieving the securing and shock absorbing effects.
